(19) United States
(12) Patent Application Publication
(10) Pub. No.: US 2024/0232410 A1
(43) Pub. Date: Jul. 11, 2024

(54) SENSITIVE DATA PROTECTION

(71) Applicant: International Business Machines Corporation, Armonk, NY (US)

(72) Inventors: Jennifer I. Bennett, Rochester, MN (US); Theron Lee Lewis, Rochester, MN (US)

(21) Appl. No.: 18/151,503

(22) Filed: Jan. 9, 2023

(51) Int. Cl. G06F 21/62

(52) U.S. Cl. CPC G06F 21/6218; G06F 2221/2143

(57) ABSTRACT

Computer-implemented methods for sensitive data protection are provided. Aspects include storing sensitive data on a first memory device disposed in a computing system and detecting an unauthorized physical access to the computing system. Aspects also include activating an x-ray source based on the detected unauthorized physical access and deactivating the x-ray source after a threshold period of time. The x-ray source is configured to bombard the first memory device with energy particles having an energy level sufficient to damage the first memory device and cause erasure of the sensitive data stored on the first memory device.

### BACKGROUND

The present invention generally relates to sensitive data protection, and more specifically, to computer systems, computer-implemented methods, and computer program products to protect sensitive data stored in a computing device using x-rays.

Hard disk drives, solid-state drives, server assemblies, and other types of storage devices are widely used for data storage. Currently, many of these storage devices include warning systems that generate an alert upon unauthorized removal of the storage device from a computing system. While beneficial, these alerts do not prevent the actual removal of devices, nor do they prevent access to the data from a stolen device.

### SUMMARY

Embodiments of the present invention are directed to a computer-implemented method for sensitive data protection. According to an aspect, a computer-implemented method includes storing sensitive data on a first memory device disposed in a computing system and detecting an unauthorized physical access to the computing system. The method also includes activating an x-ray source based on the detected unauthorized physical access and deactivating the x-ray source after a threshold period of time. The x-ray source is configured to bombard the first memory device with energy particles having an energy level sufficient to damage the first memory device and cause erasure of the sensitive data stored on the first memory device.

According to another non-limiting embodiment of the invention, a system having a memory having computer readable instructions and one or more processors for executing the computer readable instructions, the computer readable instructions controlling the one or more processors to perform operations. The operations include storing sensitive data on a first memory device disposed in a computing system and detecting an unauthorized physical access to the computing system. The operations also include activating an x-ray source based on the detected unauthorized physical access and deactivating the x-ray source after a threshold period of time. The x-ray source is configured to bombard the first memory device with energy particles having an energy level sufficient to damage the first memory device and cause erasure of the sensitive data stored on the first memory device.

According to another non-limiting embodiment of the invention, a computer program product for sensitive data protection is provided. The computer program product includes a computer-readable storage medium having program instructions embodied therewith, the program instructions executable by a processor to cause the processor to perform operations. The operations include storing sensitive data on a first memory device disposed in a computing system and detecting an unauthorized physical access to the computing system. The operations also include activating an x-ray source based on the detected unauthorized physical access and deactivating the x-ray source after a threshold period of time. The x-ray source is configured to bombard the first memory device with energy particles having an energy level sufficient to damage the first memory device and cause erasure of the sensitive data stored on the first memory device.

Additional technical features and benefits are realized through the techniques of the present invention. Embodiments and aspects of the invention are described in detail herein and are considered a part of the claimed subject matter. For a better understanding, refer to the detailed description and to the drawings.

### BRIEF DESCRIPTION OF THE DRAWINGS

The specifics of the exclusive rights described herein are particularly pointed out and distinctly claimed in the claims at the conclusion of the specification. The foregoing and other features and advantages of the embodiments of the invention are apparent from the following detailed description taken in conjunction with the accompanying drawings in which:

FIG. 1 depicts a block diagram of an example computer system for use in conjunction with one or more embodiments of the present invention;

FIG. 2 is a block diagram of a system for sensitive data protection in accordance with one or more embodiments of the present invention;

FIG. 3 is a flowchart of a method for sensitive data protection in accordance with one or more embodiments of the present invention;

FIG. 4 is a flowchart of another method for sensitive data protection in accordance with one or more embodiments of the present invention;

FIG. 5A is a schematic diagram of a system for sensitive data protection in accordance with one or more embodiments of the present invention; and

FIG. 5B is a schematic diagram of a portion of another system for sensitive data protection in accordance with one or more embodiments of the present invention.

### DETAILED DESCRIPTION

As discussed above, currently available storage devices include warning systems that generate an alert upon unauthorized removal of the storage device from a computing system but do not prevent access to data from being accessed on the storage devices after their unauthorized removal. Disclosed herein are methods, systems, and computer program products for sensitive data protection that are configured to prevent sensitive stored on a storage device from being accessed after an unauthorized removal of the storage device from a computing system. In exemplary embodiments, the sensitive data protection system includes a tamper detection system that is configured to detect unauthorized access to a computing system and an x-ray source that is responsively activated based on unauthorized access. The x-ray source is configured to bombard the storage device with energy particles having an energy level sufficient to damage the storage device and cause erasure of the sensitive data stored on the storage device.

Various aspects of the present disclosure are described by narrative text, flowcharts, block diagrams of computer systems, and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as protecting sensitive data 150. In addition to block 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI), device set 123, storage 124, and Internet of Things (IOT) sensor set 125), and network module 115. Remote server 104 includes remote database 130. Public cloud 105 includes gateway 140, cloud orchestration module 141, host physical machine set 142, virtual machine set 143, and container set 144.

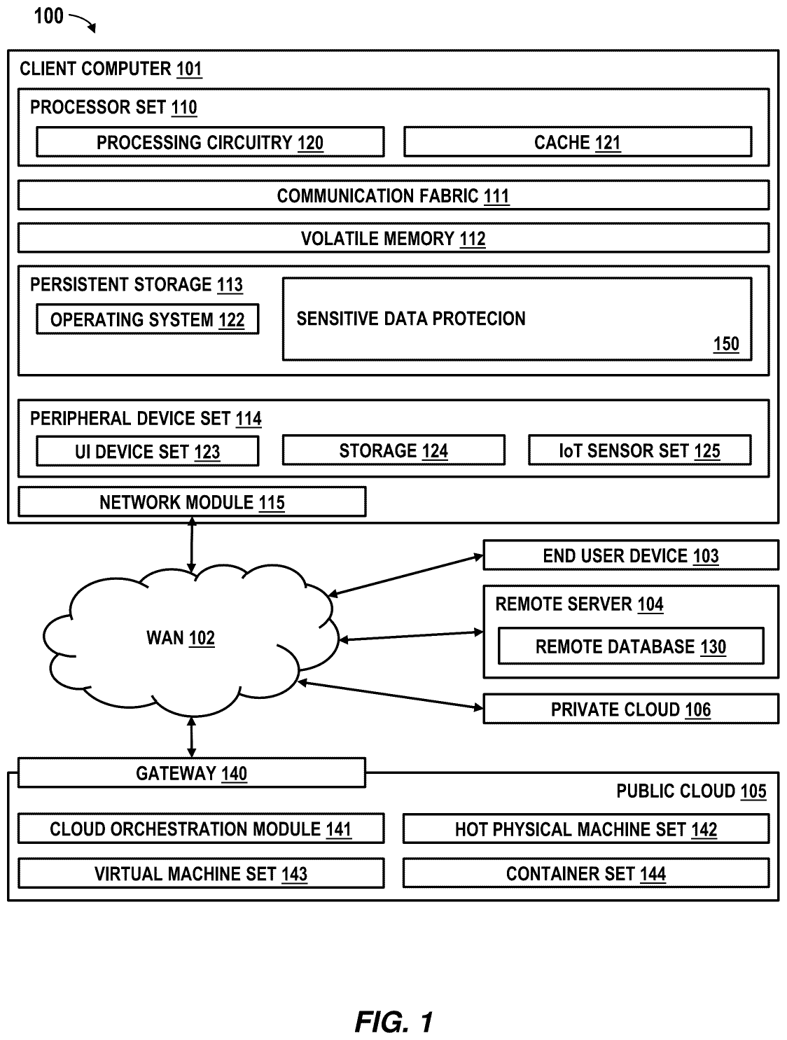

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

COMMUNICATION FABRIC 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in block 150 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collects and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

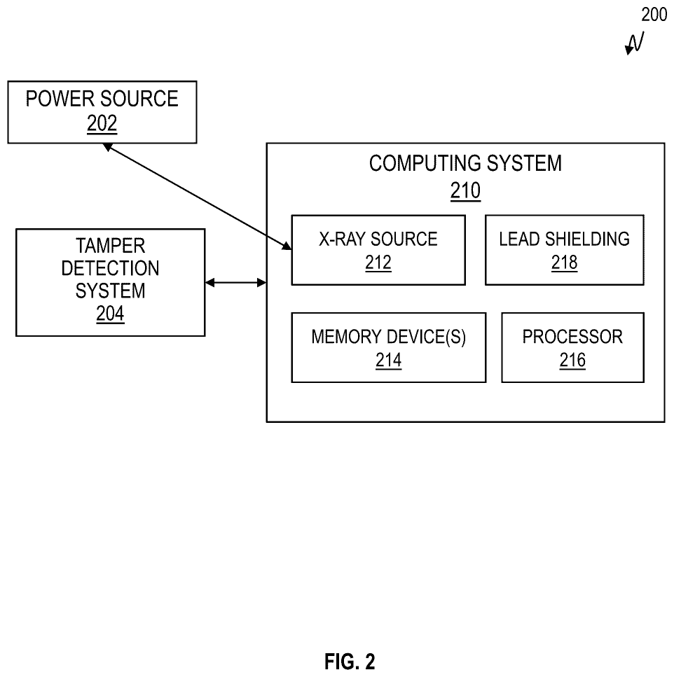

Referring now to FIG. 2, a system 200 for sensitive data protection in accordance with one or more embodiments of the present invention is shown. As illustrated, the system 200 includes a computing system 210, a tamper detection system 204, and a power source 202. In exemplary embodiments, the tamper detection system 204 is configured to detect unauthorized physical access attempts for the computing system 210. The computing system 210 includes an x-ray source 212, one or more memory devices 214, a processor 216, and lead shielding 218. In exemplary embodiments, the computing system 210 may be embodied in a computer 101, such as the one shown in FIG. 1.

In exemplary embodiments, at least one of the memory devices 214 is configured to store sensitive data. Upon the detection of an unauthorized access attempt by the tamper detection system 204, the x-ray source 212 is configured to bombard at least one of the memory device 214 with energy particles having an energy level sufficient to damage at least one of the memory device 214 and cause erasure of the sensitive data stored on the at least one of the memory device 214. In one embodiment, the processor 216 is configured to receive data from the tamper detection system 204 and to responsively activate the power source 202, thereby activating the x-ray source 212.

In one embodiment, the x-ray source 212 is configured to emit a focused beam of high energy particles that are configured to only impact the memory device(s) 214 which include stored sensitive data. In other embodiments, the x-ray source 212 is configured to emit a broad beam of high energy particles that are configured to impact memory devices 214 that include stored sensitive data and other components of the computing system 210. In one embodiment, the lead shielding 218 of the computing system 210 is configured to prevent transmission of the energy particles emitted from the x-ray source 212 to outside of the computing system 210. In another embodiment, the lead shielding 218 of the computing system 210 is configured to prevent the energy particles emitted from the x-ray source 212 from impacting one or more components of the computing system 210.

In exemplary embodiments, the tamper detection system 204 is configured to detect unauthorized physical access attempts to the computing system 210. The tamper detection system 204 may be a hardware system, a software system, or a combination of the two. In one embodiment, the tamper detection system 204 includes a physical key that is used to indicate that access to the computing system 210 is authorized. In other embodiments, the tamper detection system 204 may utilize one or more of a biometric authentication system, a security code authentication system, a dual-factor authentication system, or a combination of one or more of these systems.

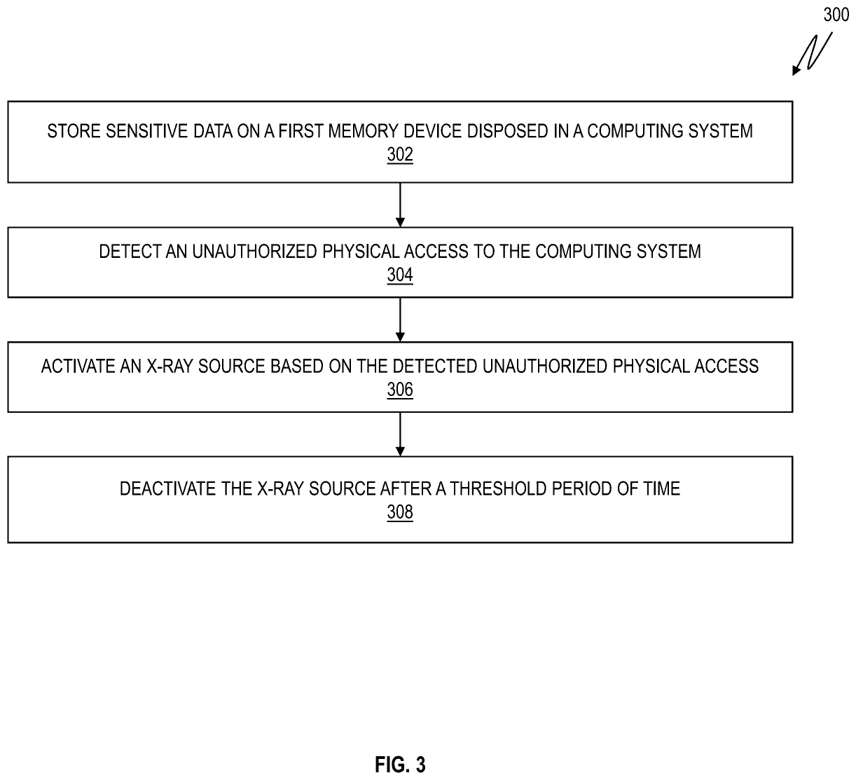

Referring now to FIG. 3, a flowchart of a method 300 for sensitive data protection in accordance with one or more embodiments of the present invention is shown. As shown at block 302, the method 300 includes storing sensitive data on a first memory device disposed in a computing system. Next, as shown at block 304, the method 300 includes detecting unauthorized physical access to the computing system. Based on detecting unauthorized physical access to the computing system, the method 300 includes activating an x-ray source, as shown at block 306. In one embodiment, the x-ray source is configured to only bombard the first memory device with the energy particles. In exemplary embodiments, the method also includes preventing the activation of the x-ray source based on detecting authorized physical access to the computing system.

The method 300 concludes at block 308 by deactivating the x-ray source after a threshold period of time. In exemplary embodiments, the x-ray source is configured to bombard the first memory device with energy particles having an energy level sufficient to damage the first memory device and cause the erasure of the sensitive data stored on the first memory device. In exemplary embodiments, the energy level is directly related to the distance between the first memory device and the x-ray source, (i.e., the closer the x-ray source is to the first memory device, the lower energy level is required). In exemplary embodiments, the energy level is inversely related to the duration of the threshold period of time, (i.e., the closer the x-ray source is to the first memory device, the shorter the duration of the threshold period of time).

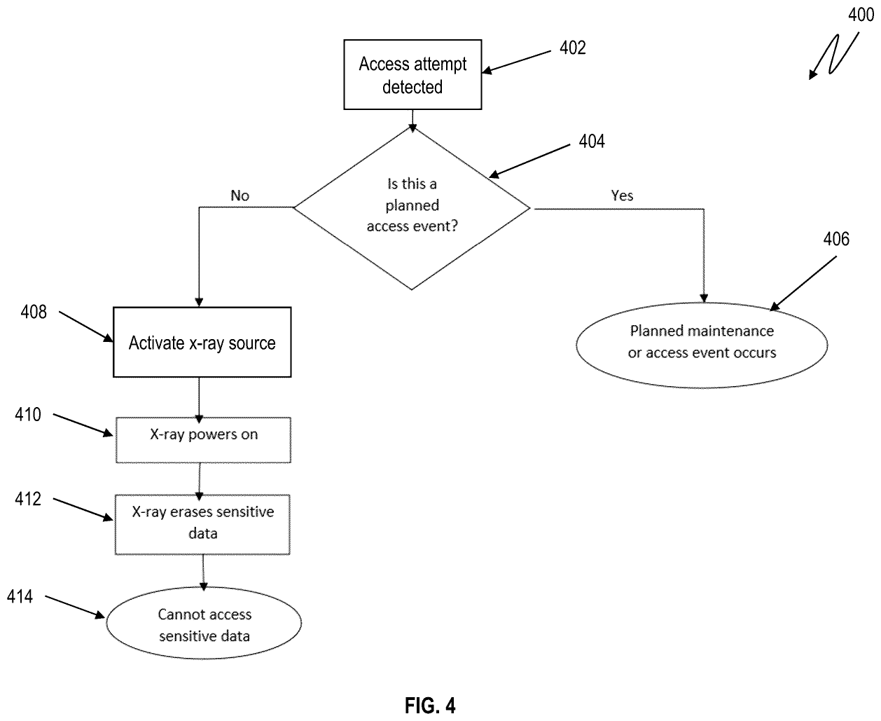

Referring now to FIG. 4, a flowchart of a method 400 for sensitive data protection in accordance with one or more embodiments of the present invention is shown. As shown at block 402, the method 400 includes detecting an access attempt of a computing system. Next, at decision block 404, a determination is made of whether the access attempt is a planned access event. If the access attempt is a planned access event, the method 400 proceeds to block 406 and the access attempt is allowed. If the access attempt is not a planned access event, the method 400 proceeds to block 408 and a controller activates the x-ray source. Next, as shown at block 410, the method 400 includes powering on the x-ray device. At block 412, the method 400 includes the x-ray device erasing sensitive data stored on a memory device by bombarding the memory device with energy particles. The method 400 concludes at block 414 and access to the sensitive data is prevented. In exemplary embodiments, bombarding the memory device with energy particles not only erases the sensitive data stored on the memory device, but it also damages the memory device such that the memory device is no longer functional.

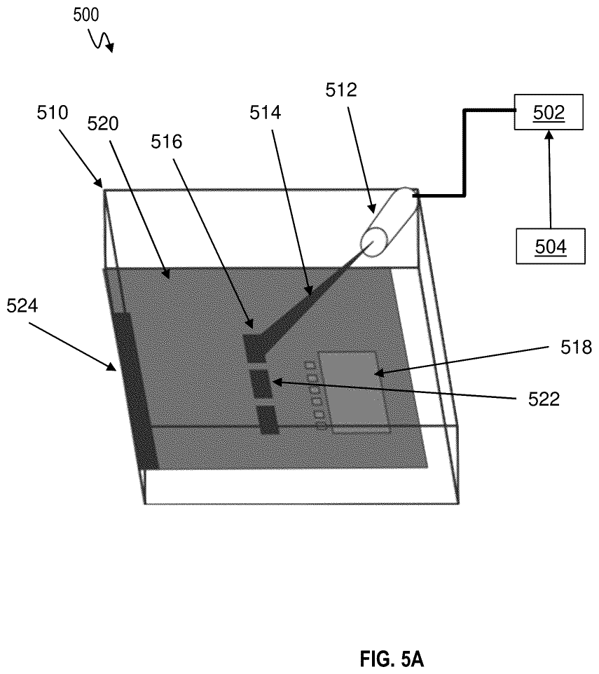

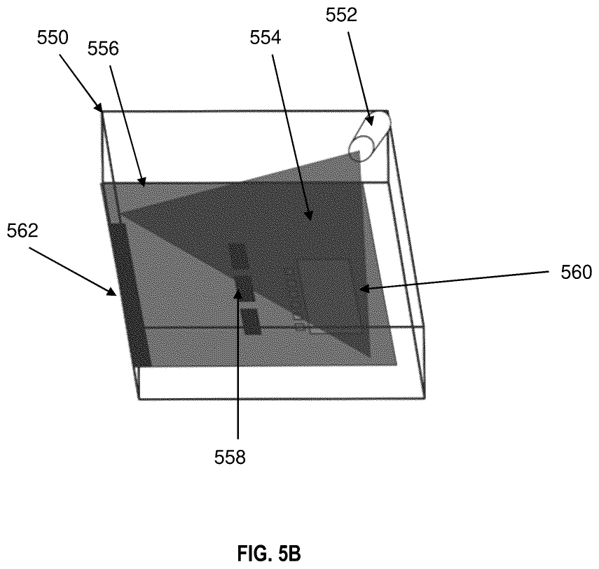

Referring now to FIG. 5A, a system 500 for sensitive data protection in accordance with one or more embodiments of the present invention is shown. As illustrated, the system 500 includes a computing system 510, a power source 502 and a tamper detection system 504. Although the tamper detection system 504 is illustrated as being separate from the computing system 510 and the power source 502, it will be appreciated by those of skill in the art that the tamper detection system 504 may be part of the computing system 510 or part of the power source 502.

The computing system 510 includes a circuit board 520 that includes a first memory device 516 that is configured to store sensitive data, a second memory device 522, and a processor 518. The computing system 510 also includes an x-ray source 512 that is configured to emit a beam 514 of energy particles that will impact the first memory device 516. Although the x-ray source 512 is illustrated as being disposed within the computing system 510, it will be appreciated by those of skill in the art that x-ray source 512 may be at least partially disposed outside of the computing system 510. In exemplary embodiments, the computing system 510 also includes one or more lead shielded surfaces 524 that are configured to prevent the energy particles emitted by the x-ray source 512 from being transmitted outside of the computing system 510.

Referring now to FIG. 5B, a computing system 550 for sensitive data protection in accordance with one or more embodiments of the present invention is shown. As illustrated, the system 550 includes a circuit board 556 that includes a plurality of memory devices 558, one or more of which is configured to store sensitive data, and a processor 560. The computing system 550 also includes an x-ray source 552 that is configured to emit a beam 554 of energy particles that will impact the components on the circuit board 556. In exemplary embodiments, an energy level of the beam 554 of energy particles is configured to be sufficient to erase the sensitive data stored on the memory devices 558 while not damaging the processor 560. In exemplary embodiments, the computing system 550 also includes one or more lead shielded surfaces 562 that are configured to prevent the energy particles emitted by the x-ray source 552 from being transmitted outside of the computing system 550.

X-rays with high photon energies above 5-10 keV (below 0.2-0.1 nm wavelength) are called hard X-rays, while those with lower energy (and longer wavelength) are called soft X-rays. In general, soft X-rays cause damage to computing devices with floating gate designs that are used in memory devices made with Si and/or Ga. The energy level for this damage is generally between two to nine keV. The dosage of the x-ray increases with greater power, longer time, and shorter distance between the concerned device and x-ray source. The relationship between dosage, time and distance can be represented as:

$$D = \frac{g * k {V}^{2} * I * t}{{d}^{2}}$$

where the D is the dosage, g is the number of Grays (Joules/kg), g is a constant, kV is a voltage, t is a time that the x-ray device is active, I is a current, and d is a distance between the x-ray source and the device. In one embodiment, for flash memory damage to cause data erasure the X-ray source provides about 2.5 Grays/sec or more, and the memory device is located within 4 inches of the x-ray source.

Various embodiments of the invention are described herein with reference to the related drawings. Alternative embodiments of the invention can be devised without departing from the scope of this invention. Various connections and positional relationships (e.g., over, below, adjacent, etc.) are set forth between elements in the following description and in the drawings. These connections and/or positional relationships, unless specified otherwise, can be direct or indirect, and the present invention is not intended to be limiting in this respect. Accordingly, a coupling of entities can refer to either a direct or an indirect coupling, and a positional relationship between entities can be a direct or indirect positional relationship. Moreover, the various tasks and process steps described herein can be incorporated into a more comprehensive procedure or process having additional steps or functionality not described in detail herein.

One or more of the methods described herein can be implemented with any or a combination of the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

For the sake of brevity, conventional techniques related to making and using aspects of the invention may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

In some embodiments, various functions or acts can take place at a given location and/or in connection with the operation of one or more apparatuses or systems. In some embodiments, a portion of a given function or act can be performed at a first device or location, and the remainder of the function or act can be performed at one or more additional devices or locations.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The present disclosure has been presented for purposes of illustration and description, but is not intended to be exhaustive or limited to the form disclosed. Many modifications and variations will be apparent to those of ordinary skill in the art without departing from the scope and spirit of the disclosure. The embodiments were chosen and described in order to best explain the principles of the disclosure and the practical application, and to enable others of ordinary skill in the art to understand the disclosure for various embodiments with various modifications as are suited to the particular use contemplated.

The diagrams depicted herein are illustrative. There can be many variations to the diagram or the steps (or operations) described therein without departing from the spirit of the disclosure. For instance, the actions can be performed in a differing order or actions can be added, deleted or modified. Also, the term “coupled” describes having a signal path between two elements and does not imply a direct connection between the elements with no intervening elements/connections therebetween. All of these variations are considered a part of the present disclosure.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” are understood to include any integer number greater than or equal to one, i.e. one, two, three, four, etc. The terms “a plurality” are understood to include any integer number greater than or equal to two, i.e. two, three, four, five, etc. The term “connection” can include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” can include a range of #8% or 5%, or 2% of a given value.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instruction by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

What is claimed is:

1. A method for sensitive data protection, the method comprising:
storing sensitive data on a first memory device disposed in a computing system;
detecting an unauthorized physical access to the computing system;
activating an x-ray source based on the detected unauthorized physical access; and
deactivating the x-ray source after a threshold period of time,
wherein the x-ray source is configured to bombard the first memory device with energy particles having an energy level sufficient to damage the first memory device and cause erasure of the sensitive data stored on the first memory device.

2. The method of claim 1, wherein the x-ray source is configured to only bombard the first memory device with the energy particles.

3. The method of claim 1, wherein the energy level is directly related to a distance between the first memory device and the x-ray source.

4. The method of claim 1, wherein the energy level is inversely related to a duration of the threshold period of time.

5. The method of claim 1, further comprising preventing the activation of the x-ray source based on detecting an authorized physical access to the computing system.

6. The method of claim 1, wherein the x-ray source is disposed within the computing system.

7. The method of claim 6, wherein the computing system includes one or more lead shielded surfaces configured to prevent a transmission of the energy particles outside of the computing system.

8. A computing system comprising:
a first memory device configured to store sensitive data;
an x-ray source; and
a tamper detection system configured to detect an unauthorized physical access to the computing system,
wherein the tamper detection system is configured to activate the x-ray source based on the detected unauthorized physical access, and
wherein the x-ray source is configured to bombard the first memory device with energy particles having an energy level sufficient to damage the first memory device and cause erasure of the sensitive data stored on the first memory device.

9. The computing system of claim 8, wherein the x-ray source is configured to only bombard the first memory device with the energy particles.

10. The computing system of claim 8, wherein the energy level is directly related to a distance between the first memory device and the x-ray source.

11. The computing system of claim 8, wherein the energy level is inversely related to a duration of the threshold period of time.

12. The computing system of claim 8, wherein the tamper detection system is further configured to prevent the activation of the x-ray source based on detecting an authorized physical access to the computing system.

13. The computing system of claim 8, wherein the computing system includes one or more lead shielded surfaces configured to prevent a transmission of the energy particles outside of the computing system.

14. A computer program product comprising a computer readable storage medium having program instructions embodied therewith, the program instructions executable by a processor to cause the processor to perform operations comprising:
storing sensitive data on a first memory device disposed in a computing system;
detecting an unauthorized physical access to the computing system;
activating an x-ray source based on the detected unauthorized physical access; and
deactivating the x-ray source after a threshold period of time,
wherein the x-ray source is configured to bombard the first memory device with energy particles having an energy level sufficient to damage the first memory device and cause erasure of the sensitive data stored on the first memory device.

15. The computer program product of claim 14, wherein the x-ray source is configured to only bombard the first memory device with the energy particles.

16. The computer program product of claim 14, wherein the energy level is directly related to a distance between the first memory device and the x-ray source.

17. The computer program product of claim 14, wherein the energy level is inversely related to a duration of the threshold period of time.

18. The computer program product of claim 14, wherein the operations further comprise: preventing the activation of the x-ray source based on detecting an authorized physical access to the computing system.

19. The computer program product of claim 14, wherein the x-ray source is disposed within the computing system.

20. The computer program product of claim 19, wherein the computing system includes one or more lead shielded surfaces configured to prevent a transmission of the energy particles outside of the computing system.
